(19) United States
(12) Patent Application Publication
(10) Pub. No.: US 2018/0259344 A1
(43) Pub. Date: Sep. 13, 2018

(54) SYSTEM FOR BUILDING SITUATION AWARENESS

(71) Applicant: ROLLS-ROYCE plc, London (GB)

(72) Inventor: Lily RACHMAWATI, Singapore (SG)

(73) Assignee: ROLLS-ROYCE plc, London (GB)

(21) Appl. No.: 15/919,430

(22) Filed: Mar. 13, 2018

(30) Foreign Application Priority Data
Mar. 13, 2017 (GB) 1703968.6

(51) Int. Cl. G01C 21/20; G05D 1/02; G01S 13/86; G08G 3/00

(52) U.S. Cl. CPC G01C 21/203; G08G 3/00; G01S 13/865; G05D 1/0206

(57) ABSTRACT

A system for generating a map for use in the navigation of one or more vessels includes: one or more sensor sub-systems provided on a vessel and configured for sensing, in real-time, the presence of obstacles within a local environment of the vessel; a processor associated with the one or more sensor sub-systems for collecting the sensor data and configured for generating therefrom, in a serialised digital format, a real-time map of the local environment surrounding the vessel; data communication means between the processor and a remotely located hub in data communication with remote sensing systems located remotely from the vessel. The hub is configured to collect sensor data from a source remote from the vessel and communicate the sensor data to the processor. The processor is configured on receipt of additional sensor data to generate a real-time map from the sensor data.

### CROSS-REFERENCE TO RELATED APPLICATIONS

This application is based upon and claims the benefit of priority from British Patent Application Number 1703968.6 filed Mar. 13, 2017, the entire contents of which are incorporated by reference.

### BACKGROUND

### Field

The present invention relates to the building of map data to assist the navigation of a vessel. For example, but without limitation, the vessel may be one of a fleet of unmanned vessels.

### Description of Related Art

It is known for unmanned vessels to use on board sensing systems to build a local map of their environment in real time and to use this map for self-navigation. Map data collected may identify static obstacles such as land masses as well as dynamic obstacles such as other vessels moving within the mapped environment.

Current concepts and technologies combine multiple sensors of various types to compensate for limited range/accuracy of individual sensors in various settings. Whilst these can be effective in generating a comprehensive map of the nearby environment, influences within that environment such as extremes of weather can affect sensor range and accuracy impairing a vessel's self-navigation. Another significant influence is the presence of (larger and nearer) objects occluding the view of other objects (smaller and further away) from the vessel.

### BRIEF SUMMARY OF THE INVENTION

The sharing of data between multiple sub-systems is known. Such information sharing is not typically done on a selective basis.

The present invention seeks to overcome limitations of these prior known technologies.

In accordance with the present invention there is provided a system for generating a map for use in the navigation of one or more vessels, the system comprising: one or more sensor sub-systems provided on a vessel and configured for sensing, in real-time, the presence of obstacles within a local environment of the vessel; a processor associated with the one or more sensor sub-systems for collecting the sensor data and configured for generating therefrom, in a serialised digital format, a real-time map of the local environment surrounding the vessel; data communication means between the processor and a remotely located hub, the hub in data communication with one or more remote sensing systems located remotely from the vessel; wherein, the hub is configured to collect additional sensor data from a source remote from the vessel and communicate the additional sensor data to the processor, and, the processor is configured on receipt of additional sensor data to generate a real-time map from the sensor data and the additional sensor data.

In an option, the hub is configured to be responsive to the identification of gaps in a real-time map generated only from sensor data collected by the vessel's sensor sub-systems to identify a remote sensing system positioned to collect additional sensor data in the gap and communicate the additional sensor data to the processor; and the processor is configured on receipt of the additional sensor data to mesh a real-time map generated from the additional sensor data with the real-time map generated from the sensor data collected by the vessel's sensor sub-systems.

In another option the additional sensor data is used to verify or improve the accuracy of real-time map data versus real-time map data generated from the sensor data alone.

The processor or hub may be further configured to identify gaps in a real-time map of the local environment surrounding the vessel. For example, location of a gap may be communicated to the hub in the form of map coordinate data.

For example, but without limitation, the sensor sub-systems may comprise; a camera, an infrared imaging system, lidar, radar or any combination thereof.

The hub may be in data communication with one or more geographic information systems (for example ArcGIS), vessel traffic management systems (VTMS) or vessel automatic identification systems (AIS). Where a gap in the real-time map is identified, the one or more systems may be interrogated for information relating to the gap. Information useful in mapping the gap can be communicated to the vessel based processor and meshed with the real-time map of the local environment surrounding the vessel.

The hub may be in data communication with systems on one or more other vessels from which real-time map data can be accessed. The hub may be configured to request from the one or more other vessels, real-time map data related to the location of an identified gap. Relevant data may be communicated via the hub to the vessel for which the gap in the real-time map data has been identified.

The hub may be configured to aggregate obstacle data from the various remote sensing systems and the requesting vessel and generate therefrom, in a serialised digital format, a real-time map of the global environment in which a fleet of vessels exists. The hub may be further configured to identify inconsistencies in data collected for any given location within the global map and to identify that location as a gap. Further sensor data may then be collected in the given location allowing certainty and accuracy of the global map data to be improved.

The hub may be enabled to control one or more drones, each drone having a sensing system for sensing, in real-time, the presence of obstacles within a local environment of the drone. Responsive to the identification of gaps in the real-time map data, the hub may despatch one or more drones to the location of the identified gap to collect missing data. Once collected, the data can be communicated back to the vessel's on board processor.

For example, data may be communicated via an internet cloud-based infrastructure. Alternatively or in addition, low frequency microwave radio may be used for such communication. The latter is advantageous in not being significantly affected by weather conditions such as fog and heavy rain.

Where an unexpected dynamic obstacle is identified in the additional sensor data, the hub may be configured to determine a pattern of movement of the unexpected dynamic obstacle and predict a future pattern of movement of the unexpected dynamic obstacle. The pattern of movement may be determined from a collection of dynamic obstacle data collected at known time intervals and optionally from multiple remote sensing systems. Such data may be used to determine a direction of travel of the dynamic obstacle and speed of travel and can be extrapolated to predict a future pattern of movement. The predicted path of the unexpected dynamic obstacle may be communicated to vessels known to be in a vicinity of the predicted path. Optionally, the hub may be configured to assess a risk of interception of the predicted path of the unexpected dynamic obstacle with a planned route of one or more vessels and only in the event of a predicted interception, communicates an alert to the vessel. An alert communicated to the vessel may include an instruction for defensive action such as a change in speed of the vessel or a change in the planned route of the vessel.

Predicted paths of identified dynamic data may be represented in map data stored in the hub and communicated to individual vessels. In this manner, vessels may be made aware of dynamic obstacles in their vicinity which they have not independently detected.

The system may be embodied in a fleet of marine vessels. The vessels may be manned or unmanned or a combination of manned and unmanned.

Real-time map data from processors on each of a plurality of vessels all in data communication with the hub may be shared via the hub.

### BRIEF DESCRIPTION OF THE DRAWINGS

An embodiment of the invention will now be described by way of example with reference to the accompanying Figures in which;

FIG. 1 shows a fleet of vessels in which a system in accordance with the invention is embodied;

FIG. 2 illustrates the building of a map using the system represented in FIG. 1;

FIG. 3 illustrates process steps taken by a system in accordance with the invention in generating a map for use in the navigation of one or more vessels.

### DETAILED DESCRIPTION OF THE INVENTION

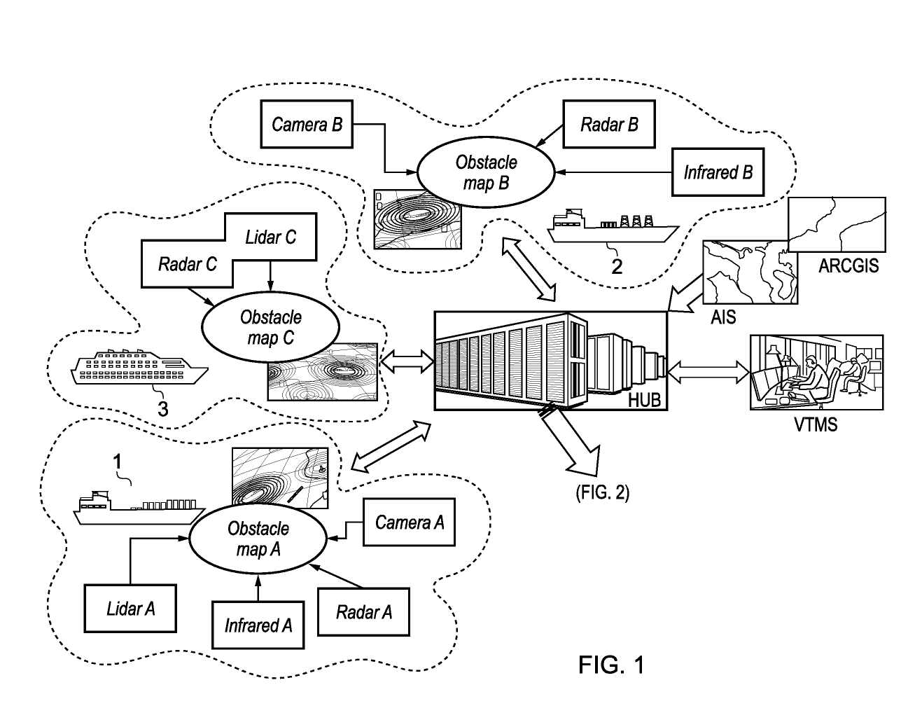

As can be seen in FIG. 1, a fleet comprises vessels 1, 2 and 3. Each vessel is equipped with sensor sub-systems configured for sensing, in real-time, the presence of obstacles within a local environment of the vessel. Vessel 1 is equipped with sensor sub-systems Lidar A, Infrared A, Radar A and Camera A. A processor on board Vessel 1 collects data from these sub-systems and generates Obstacle Map A which is a real-time map representation of local environment within which Vessel 1 is located. Vessel 2 is equipped with sensor sub-systems Camera B, Radar B and Infrared B. A processor on board Vessel 2 collects data from these sub-systems and generates Obstacle Map B which is a real-time map representation of local environment within which Vessel 2 is located. Vessel 3 is equipped with sensor sub-systems Radar C, Lidar C. A processor on board Vessel 3 collects data from these sub-systems and generates Obstacle Map C which is a real-time map representation of local environment within which Vessel 3 is located. Each of Vessel 1, Vessel 2 and Vessel 3 is in data communication with the HUB which is able to build a combined map from map data received from individual vessel maps communicated to it. In addition, the HUB is in data communication with remote systems ARCGIS, AIS and VTMS which are each equipped to provide dynamic and/or static obstacle data by means of sensor systems on vessels in other fleets, from land-based sensor systems and/or from satellite based sensor systems.

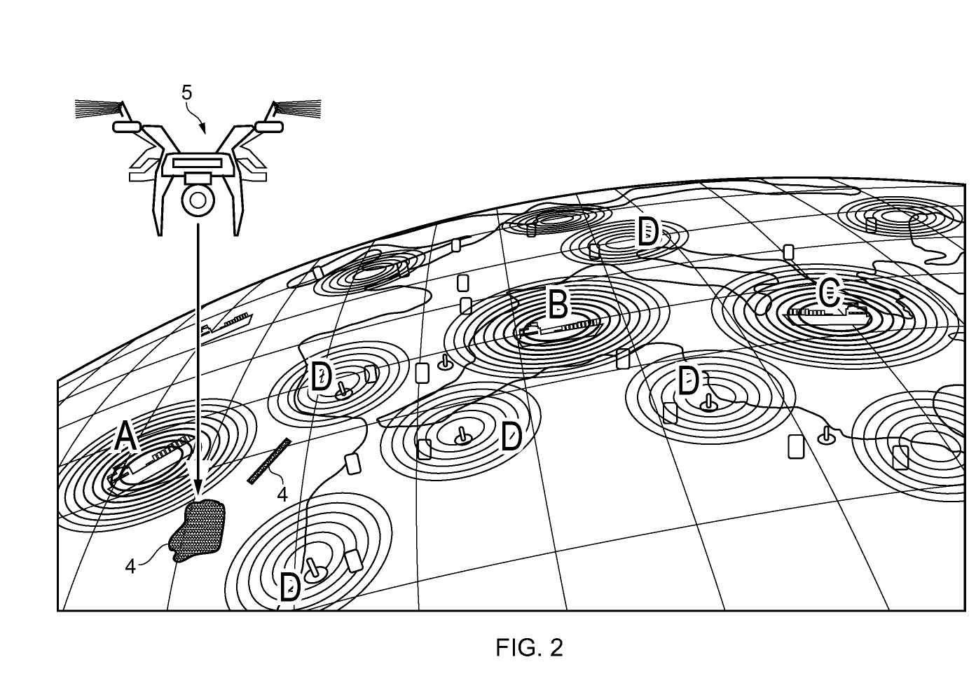

FIG. 2 illustrates a planet surface with each of the Obstacle Maps A, B and C represented thereon. The regions marked D represent map data obtainable by the hub from the remote systems ARCGIS, AIS and VTMS. As can be seen Obstacle Map A of Vessel 1 is some distance from adjacent maps D resulting in a dark unmapped areas 4. Having access to data from all Obstacle Maps A, B and C and remote system maps D, the HUB is able to identify an absence of map data in the unmapped areas 4. The HUB is enabled to control the despatch of a drone 5 to the unmapped areas 4. The drone 5 which is in data communication with the HUB is provided with sensors for collecting obstacle data in its local environment. The HUB receives obstacle data from the previously unmapped areas 4 and is able to communicate this to Vessel 1. A processor on Vessel 1 is able then to mesh map data generated from the drone's obstacle data with the Obstacle Map A data, thereby widening the local environment mapped by Vessel 1 and facilitating easier navigation of Vessel 1 from its current location to a pre-defined destination.

It will be appreciated that whilst the shown embodiment demonstrates how missing map data can be obtained and provided to a vessel, a similar data collection system can be used to collect additional obstacle data in a region overlapping with the Obstacle Map A. Such additional data, when meshed with the Obstacle A data, can be used to verify and/or improve accuracy of the Obstacle Map A data. This can be particular beneficial when the sensitivity or range of one or more sensor sub-systems Camera A, Radar A, Infrared A, Lidar A is diminished due, for example, to inclement weather in the local environment. Sensitivity of remote systems positioned to collect data in the same local environment may not be so diminished due to their remote location and can provide better quality obstacle data in that instance.

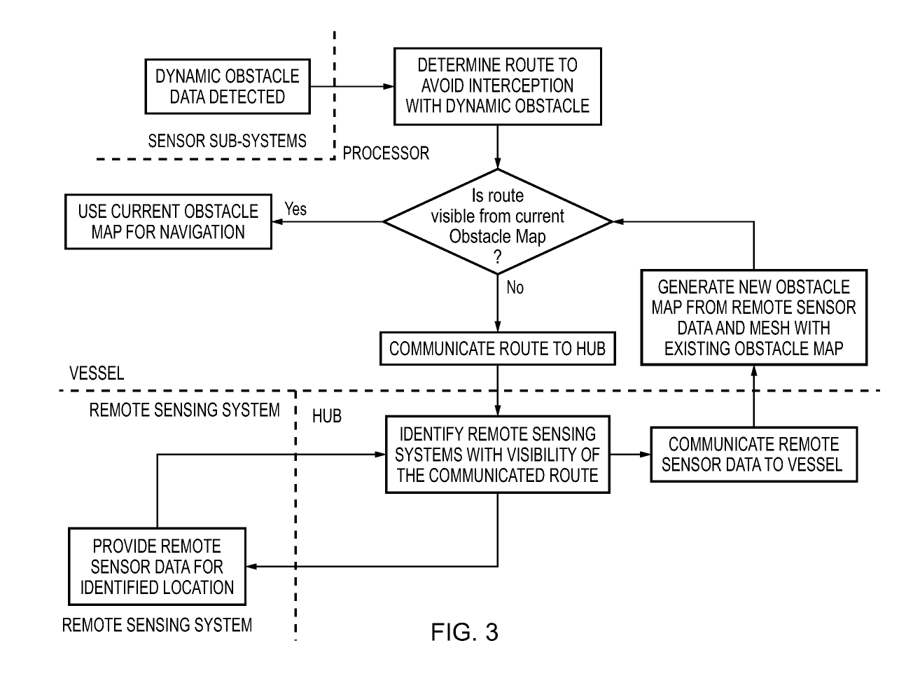

Embodiments of the system may be configured such that there is selectivity in the communication of map data between the hub and any vessel in the fleet. For example, the hub may be configured to be responsive to a request from an individual vessel to obtain and supply additional obstacle data from remote sensing systems. An example of a method performed by such an embodiment of the system is illustrated in FIG. 3.

As can be seen from FIG. 3, a sensor sub-system located on a vessel detects the presence of a dynamic obstacle in a local environment of the vessel. This information is communicated to an on board processor. In a case where the detected dynamic obstacle presents a risk to the vessel (for example a risk of collision or unwanted detection), the processor determines a change to its current route to avoid the dynamic obstacle. In order to navigate the new route, the processor needs map data surrounding the new route. This map data might not be accessible by the vessel's sensor sub-systems. The processor identifies a gap in the required map data and communicates location details of the gap to a remotely located hub.

On receipt of the location details, the hub interrogates one or more remote sensing systems such as (without limitation) other vessels in a fleet, ARCGIS or VTMS to locate relevant obstacle data for the communicated location. Identified relevant obstacle data is then communicated back to the vessel processor via the hub. The vessel's processor then generates a real-time map for a location through which the new route is to pass.

It will be appreciated that by contrast to prior known shared data systems where a vessel may be communicated shared data from a number of sources whether or not it has a need for that data, the proposed system of the invention provides only data which is relevant to a vessel's current situation and the data is communicated on an as needed basis. This reduces data traffic between the hub and any vessel and allows necessary and relevant data to be communicated more quickly. Since effective navigation is reliant on real-time data, particularly in regard to the presence of dynamic obstacles, the vessel is enabled to respond more quickly to potential risk situations.

It will be understood that the invention is not limited to the embodiments above-described and various modifications and improvements can be made without departing from the concepts described herein. For example, the different embodiments may take the form of an entirely hardware embodiment, an entirely software embodiment, or an embodiment containing both hardware and software elements.

Except where mutually exclusive, any of the features may be employed separately or in combination with any other features and the disclosure extends to and includes all combinations and sub-combinations of one or more features described herein.

1. A system for generating a map for use in the navigation of one or more vessels, the system comprising:
one or more sensor sub-systems provided on a vessel and configured for sensing, in real-time, the presence of obstacles within a local environment of the vessel;
a processor associated with the one or more sensor sub-systems for collecting the sensor data and configured for generating therefrom, in a serialised digital format, a real-time map of the local environment surrounding the vessel;
data communication means between the processor and a remotely located hub, the hub in data communication with one or more remote sensing systems located remotely from the vessel sensor sub-systems; wherein,
the hub is configured to collect additional sensor data from a source remote from the vessel and communicate the additional sensor data to the processor, and, the processor is configured on receipt of additional sensor data to generate a real-time map from the sensor data and the additional sensor data.

2. The system as claimed in claim 1 wherein, the hub is configured to be responsive to the identification of gaps in a real-time map generated only from sensor data collected by the vessel's sensor sub-systems to identify a remote sensing system positioned to collect additional sensor data in the gap and communicate the additional sensor data to the processor; and
the processor is configured on receipt of the additional sensor data to mesh a real-time map generated from the additional sensor data with a real-time map generated from the sensor data collected by the vessel's sensor sub-systems.

3. The system as claimed in claim 1 wherein the sensor sub-systems comprise;
a camera, an infrared imaging system, lidar, radar or any sub-set or combination thereof.

4. The system as claimed in claim 1 wherein the hub is in data communication with one or more geographic information systems, vessel traffic management systems or vessel automatic identification systems or any sub-set or combination thereof.

5. The system as claimed in claim 1 wherein the hub is in data communication with systems on one or more other vessels from which real-time map data can be accessed.

6. The system as claimed in claim 1 wherein the hub is enabled to control one or more drones, each drone having a sensing system for sensing, in real-time, the presence of obstacles within a local environment of the drone.

7. The system as claimed in claim 6 wherein, responsive to the identification of gaps in a vessel's real-time map data, the hub is configured to despatch one or more drones to the location of the identified gap to collect missing data and communicate collected missing data from the drone to the vessel.

8. The system as claimed in claim 1 wherein the hub is configured, when the additional sensor data includes dynamic obstacle data, to determine an established pattern of movement of the dynamic obstacle and predict from the established pattern of movement a future pattern of movement thereof.

9. The system as claimed in claim 8 wherein the established pattern of movement is determined from a collection of dynamic obstacle data collected at known time intervals and/or from multiple remote sensing systems.

10. The system as claimed in claim 8 wherein the hub is further configured to communicate the predicted future pattern of movement of the dynamic obstacle to vessels known to be in a vicinity of the predicted pattern of movement.

11. The system as claimed in claim 10 wherein the hub is further configured to assess a risk of interception of the predicted pattern of movement of the dynamic obstacle with a known planned route of one or more vessels and only in the event of a predicted high risk of interception, communicates an alert to the vessel.

12. The system as claimed in claim 11 wherein the alert communicated to the vessel includes an instruction for defensive action.

13. The system as claimed in claim 1 wherein the one or more vessels is an unmanned marine vessel located at sea and the hub is located on land.

14. A method for generating a map on board a vessel of a system the method comprising:
receiving sensor data from one or more sensor sub-systems indicative of the presence of obstacles,
generating from the received sensor data, in a serialised digital format, a real-time map of a local environment representing a current spatial arrangement of obstacles therein,
responsive to identification of an absence of obstacle data in a location of interest, communicating data representative of the location of interest to a remotely located hub,
receive obstacle data related to the location of interest,
generate a real-time map using the received obstacle data.

15. A method for providing missing data in a control hub of a system for generating a map for use in the navigation of one or more vessels the method comprising:
receiving from a requesting source, data representative of a location of interest, interrogating one or more data sources other than the requesting source to identify obstacle data for the location of interest,
communicating identified obstacle data of interest to the requesting source.

16. The method as claimed in claim 14 wherein the identified obstacle data includes dynamic obstacle data and comprising; predicting a future pattern of movement of the dynamic obstacle and communicating this to the requesting source.
